(19) United States
(12) Patent Application Publication
(10) Pub. No.: US 2020/0034213 A1
(43) Pub. Date: Jan. 30, 2020

(54) NODE DEVICE, PARALLEL COMPUTER SYSTEM, AND METHOD OF CONTROLLING PARALLEL COMPUTER SYSTEM

(71) Applicant: FUJITSU LIMITED, Kawasaki-shi (JP)

(72) Inventor: YUJI KONDO, Kawasaki (JP)

(73) Assignee: FUJITSU LIMITED, Kawasaki-shi (JP)

(21) Appl. No.: 16/453,267

(22) Filed: Jun. 26, 2019

(30) Foreign Application Priority Data
Jul. 25, 2018 (JP) 2018-139137

(51) Int. Cl. G06F 9/52; G06F 9/30; G06F 9/54; G06F 9/50

(52) U.S. Cl. CPC G06F 9/522; G06F 9/30098; G06F 9/542; G06F 9/5022; G06F 9/544

(57) ABSTRACT

A node device includes: a processor; and a synchronization circuit including: a plurality of registers configured to store respective data of a plurality of processes that are generated by the processor; a reduction operator configured to execute a reduction operation on the data of the plurality of processes and data of other processes generated in another node device, to generate an operation result of the reduction operation; and a controller configured to collectively notify of a completion of the reduction operation to the plurality of processes when the operation result is generated.

### CROSS-REFERENCE TO RELATED APPLICATION

This application is based upon and claims the benefit of priority of the prior Japanese Patent Application No. 2018-139137, filed on Jul. 25, 2018, the entire contents of which are incorporated herein by reference.

### FIELD

The embodiments discussed herein are related to a node device, a parallel computer system, and a method of controlling a parallel computer system.

### BACKGROUND

FIG. 1 illustrates an example of a parallel computer system. The parallel computer system of FIG. 1 includes node devices 101-1 to 101-9 that operate in parallel. Two adjacent node devices are connected to each other by a transmission line 102. In the parallel computer system, a reduction operation may be executed using data generated by each node device.

FIG. 2 illustrates an example of a reduction operation on four node devices. The parallel computer system of FIG. 2 includes node devices N0 to N3, and executes a reduction operation to obtain the sum SUM of vectors possessed by the four respective node devices. For example, when the elements of the vectors possessed by the node devices N0, N1, N2, and N3 are 1, 7, 13, and 19, respectively, the sum of the elements is 40.

As for the reduction operation, there is known a reduction operation device which executes the reduction operation while taking a barrier synchronization to stop a progress of any process or thread that has reached a barrier until all other process or threads reach the barrier. Further, there is known a broadcast communication method using a distributed shared memory.

Related technologies are disclosed in, for example, Japanese Laid-open Patent Publication No. 2010-122848, Japanese Laid-open Patent Publication No. 2012-128808, and Japanese Laid-open Patent Publication No. 2008-015617.

When multiple processing units such as jobs, tasks, processes, and threads are operating in each node device of the parallel computer system, it is redundant to notify the result of the reduction operation to each of the processing units, and this processing causes an increase of notification costs such as a packet flow rate and latency.

### SUMMARY

According to an aspect of the embodiments, a node device includes: a processor; and a synchronization circuit including: a plurality of registers configured to store respective data of a plurality of processes that are generated by the processor; a reduction operator configured to execute a reduction operation on the data of the plurality of processes and data of other processes generated in another node device, to generate an operation result of the reduction operation; and a controller configured to collectively notify of a completion of the reduction operation to the plurality of processes when the operation result is generated.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a parallel computer system;

FIG. 2 is a view illustrating a reduction operation for four node devices;

FIG. 3 is a view illustrating processes;

FIG. 4 is a view illustrating a reduction operation for sixteen processes;

FIG. 5 is a processing flow of a reduction operation;

FIG. 6 is a processing flow related to a process 0;

FIG. 7 is a configuration diagram of a node device;

FIG. 8 is a flowchart of a method of controlling a parallel computer system;

FIG. 9 is a configuration diagram of a parallel computer system;

FIG. 10 is a configuration diagram of a node device including a CPU and a communication device;

FIG. 11 is a first configuration diagram of a synchronization device;

FIG. 12 is a view illustrating register information in a notification method using a shared area;

FIG. 13 is a view illustrating a write request in the notification method using the shared area;

FIG. 14 is a view illustrating a processing flow of collectively notifying a completion of a reduction operation;

FIG. 15 is a view illustrating a processing flow related to a process 0 in the notification method using the shared area;

FIG. 16 is a configuration diagram of a lock control circuit;

FIG. 17 is a view illustrating register information in a notification method using a multicast;

FIG. 18 is a view illustrating a write request in the notification method using the multicast;

FIG. 19 is a view illustrating a processing flow related to a process 0 in the notification method using the multicast;

FIG. 20 is a second configuration diagram of the synchronization device; and

FIG. 21 is a view illustrating register information in a notification method using registers.

### DESCRIPTION OF EMBODIMENTS

Hereinafter, embodiments will be described in detail with reference to the accompanying drawings.

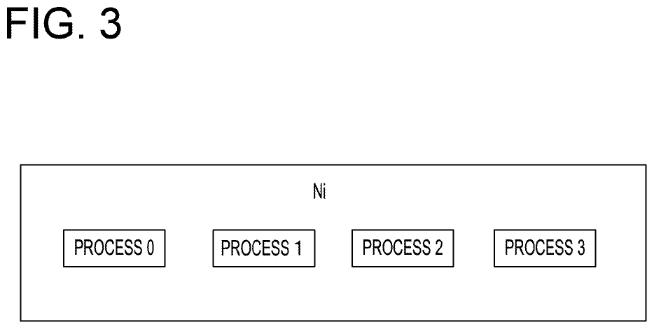

FIG. 3 illustrates an example of processes generated in each of the node devices N0 to N3. In this example, four processes 0 to 3 are generated in each node device Ni (i=0 to 3) so that a total of 16 processes execute a parallel processing.

Here, a process is an example of a processing unit in which a node device executes a processing, and may be, for example, a job, a task, a thread, or a microthread other than a process.

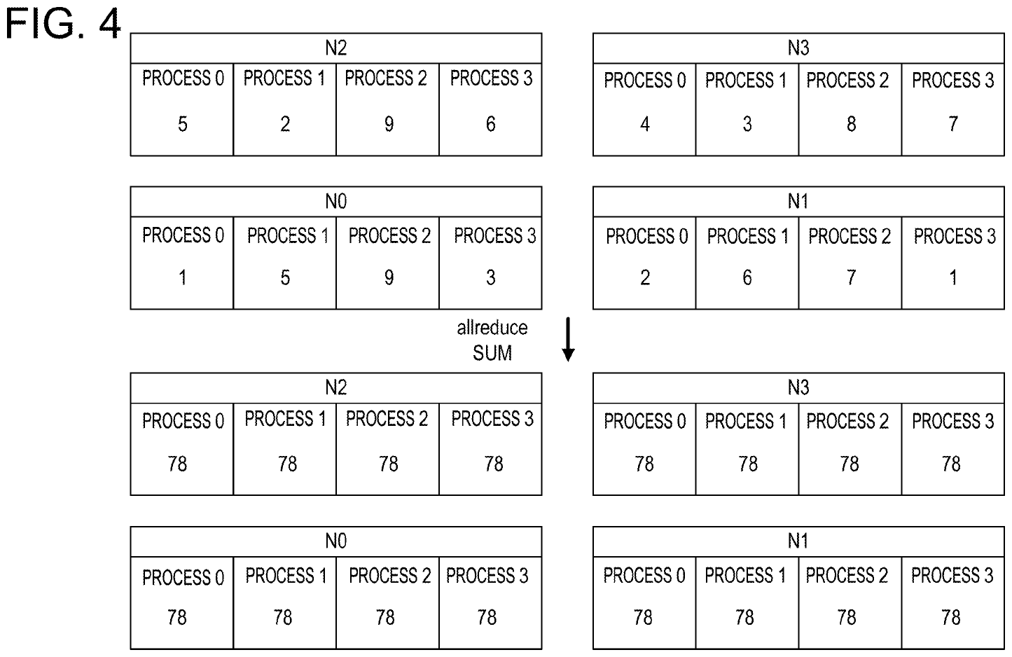

FIG. 4 illustrates an example of a reduction operation on the 16 processes of the node devices N0 to N3. The parallel computer system of FIG. 4 includes the node devices N0 to N3 and executes an “allreduce” for the 16 processes, to obtain the sum SUM of data generated by the 16 respective processes. In this example, the sum of the data of the 16 processes is 78.

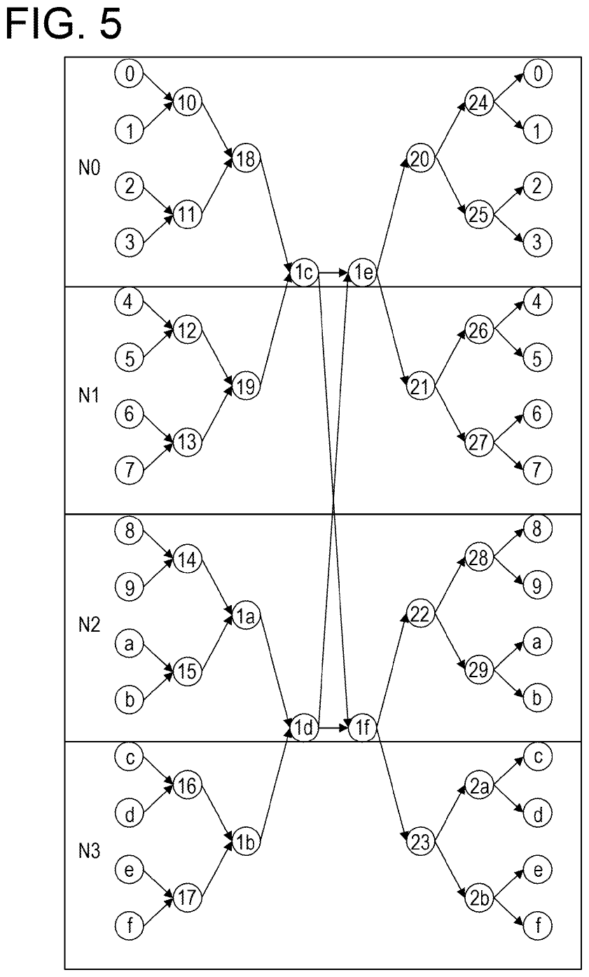

FIG. 5 illustrates an example of a processing flow when the reduction operation of FIG. 4 is executed by using a 2-input 2-output reduction operator. Each circle in the node device Ni represents a register that stores data, and a numeral or character in the circle represents identification information of each register. The reduction operation is executed while taking an inter-process synchronization.

In the node device N0, registers 0, 1, 2, and 3 are used as input/output interfaces (IFs) to store input data generated by the processes 0, 1, 2, and 3, respectively, at the time when the reduction operation is started. Meanwhile, registers 10, 11, 18, 1c, 1e, 20, 24, and 25 are used as relay IFs to store data of a standby state.

In the node device N1, registers 4, 5, 6, and 7 are used as input/output IFs to store input data generated by the processes 0, 1, 2, and 3, respectively, at the time when the reduction operation is started. Meanwhile, registers 12, 13, 19, 21, 26, and 27 are used as relay IFs to store data of a standby state.

In the node device N2, registers 8, 9, a, and b are used as input/output IFs to store input data generated by the processes 0, 1, 2, and 3, respectively, at the time when the reduction operation is started. Meanwhile, registers 14, 15, 1a, 1d, 1f, 22, 28, and 29 are used as relay IFs to store data of a standby state.

In the node device N3, registers c, d, e, and f are used as input/output IFs to store input data generated by the processes 0, 1, 2, and 3, respectively, at the time when the reduction operation is started. Meanwhile, registers 16, 17, 1b, 23, 2a, and 2b are used as relay IFs to store data of a standby state.

In the node device N0, the register 10 stores the sum of the data of the registers 0 and 1, the register 11 stores the sum of the data of the registers 2 and 3, and the register 18 stores the sum of the data of the registers 10 and 11.

In the node device N1, the register 12 stores the sum of the data of the registers 4 and 5, the register 13 stores the sum of the data of the registers 6 and 7, and the register 19 stores the sum of the data of the registers 12 and 13.

In the node device N2, the register 14 stores the sum of the data of the registers 8 and 9, the register 15 stores the sum of the data of the registers a and b, and the register 1a stores the sum of the data of the registers 14 and 15.

In the node device N3, the register 16 stores the sum of the data of the registers c and d, the register 17 stores the sum of the data of the registers e and f, and the register 1b stores the sum of the data of the registers 16 and 17.

The register is in the node device N0 stores the sum of the data of the register 18 in the node device N0 and the data of the register 19 in the node device N1. The register 1d in the node device N2 stores the sum of the data of the register is in the node device N2 and the data of the register 1b in the node device N3.

The register 1e in the node device N0 stores the sum of the data of the register is in the node device N0 and the data of the register 1d in the node device N2. The register 1f in the node device N2 stores the sum of the data of the register 1d in the node device N2 and the data of the register is in the node device N0. The data of the registers 1e and 1f are equal to the data possessed by the 16 processes.

The data of the register 1e is notified to the process 0 that corresponds to the register 0 and the process 1 that corresponds to the register 1, via the registers 20 and 24 in the node device N0. Further, the data of the register 1e is notified to the process 2 that corresponds to the register 2 and the process 3 that corresponds to the register 3, via the registers 20 and 25 in the node device N0.

The data of the register 1e is notified to the process 0 that corresponds to the register 4 and the process 1 that corresponds to the register 5, via the registers 21 and 26 in the node device N1. Further, the data of the register 1e is notified to the process 2 that corresponds to the register 6 and the process 3 that corresponds to the register 7, via the registers 21 and 27 in the node device N1.

Meanwhile, the data of the register 1f is notified to the process 0 that corresponds to the register 8 and the process 1 that corresponds to the register 9, via the registers 22 and 28 in the node device N2. Further, the data of the register 1f is notified to the process 2 that corresponds to the register a and the process 3 that corresponds to the register b, via the registers 22 and 29 in the node device N2.

The data of the register 1f is notified to the process 0 that corresponds to the register c and the process 1 that corresponds to the register d, via the registers 23 and 2a in the node device N3. Further, the data of the register 1f is notified to the process 2 that corresponds to the register e and the process 3 that corresponds to the register f, via the registers 23 and 2b in the node device N3.

In this manner, the sum of the data of the 16 processes is notified as the result of the reduction operation to the processes.

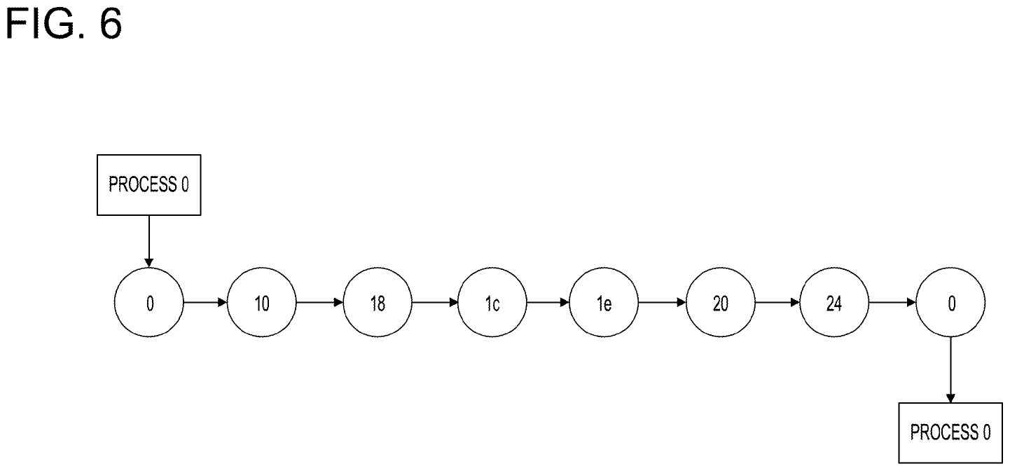

FIG. 6 illustrates an example of a processing flow related to the process 0 in the node device N0 of FIG. 5. When the reduction operation is started, the process 0 locks the register 0 and stores input data in the register 0. Then, when the operation result stored in the register 1e is notified to the process 0 via the registers 20 and 24, the register 0 is released. The processing flow related to the other processes is similar to the processing flow of FIG. 6.

For example, when the technique of Patent Document 1 is applied to the reduction operation of FIG. 4, a synchronization point is independently set for each of the multiple processes in each node device. Then, the result of the reduction operation is notified to the multiple processes in each node device in the same manner as performed in the other node devices. As the notification method, a notification by a broadcast with a tree structure or a butterfly operation may be taken into account.

However, it may be redundant to notify the same operation result to the multiple processes in each node device by the broadcast with the tree structure or the butterfly operation, and this processing causes an increase of the notification costs such as a packet flow rate and latency. Thus, the notification processing of the operation result may be effectively performed in each node device to reduce the notification costs. In addition, when the operation result is individually notified to the multiple processes in a case where the inter-process synchronization has already been established, a synchronization deviation may occur.

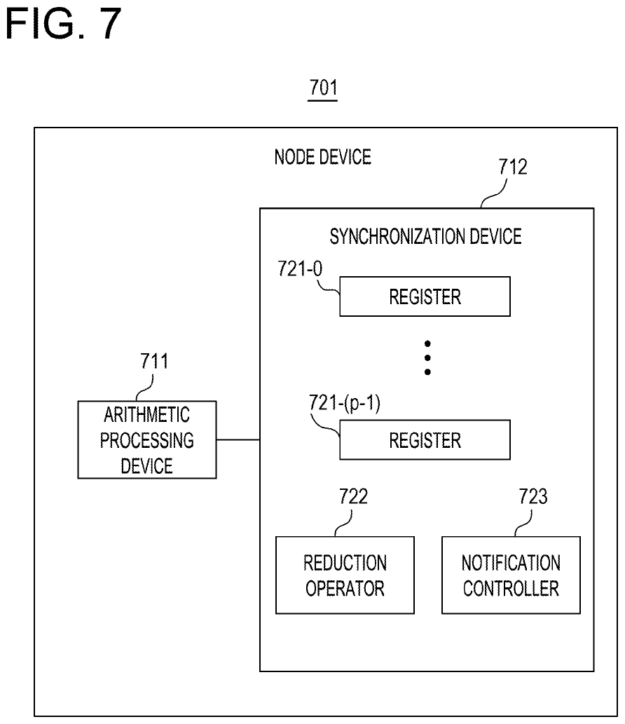

FIG. 7 illustrates an example of a configuration of each node device included in the parallel computer system of the embodiment. As illustrated in FIG. 7, a node device 701 includes an arithmetic processing device 711 and a synchronization device 712, and the synchronization device 712 includes registers 721-0 to 721-(p−1) (p is an integer of 2 or more), a reduction operator 722, and a notification controller 723. The registers 721-0 to 721-(p−1) store data of p number of processes generated by the arithmetic processing device 711, respectively.

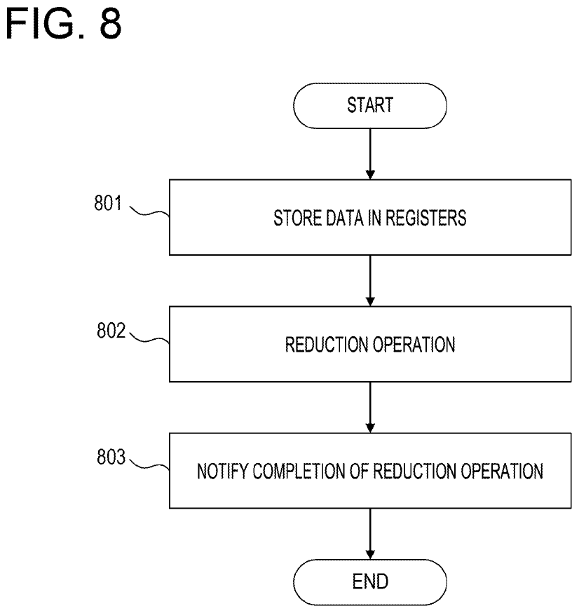

FIG. 8 is a flowchart illustrating an example of a control method of the parallel computer system including the node device 701 of FIG. 7. First, the arithmetic processing device 711 stores the data of p number of processes in the registers 721-0 to 721-(p−1), respectively (step 801).

Next, the reduction operator 722 executes the reduction operation on the data stored in the registers 721-0 to 721-(p−1) and data of processes generated in the other node devices, to generate the operation result (step 802).

Then, when the operation result is generated, the notification controller 723 collectively notifies the completion of the reduction operation to the p number of processes in the node device 701 (step 803).

According to the node device 701 of FIG. 7, it is possible to reduce the notification costs when the operation result of the reduction operation is notified to the multiple processes in the node device 701.

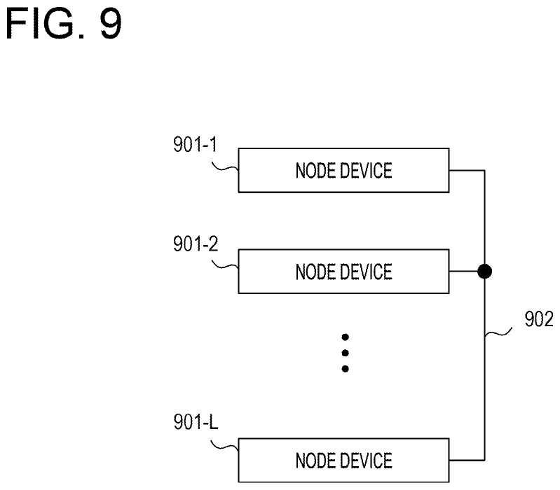

FIG. 9 illustrates an example of a configuration of the parallel computer system including the node device 701 of FIG. 7. The parallel computer system of FIG. 9 includes node devices 901-1 to 901-L (L is an integer of 2 or more). Each node device 901-i (i=1 to L) is, for example, an information processor (computer), and corresponds to the node device 701. The node devices 901-1 to 901-L are connected to each other by a communication network 902.

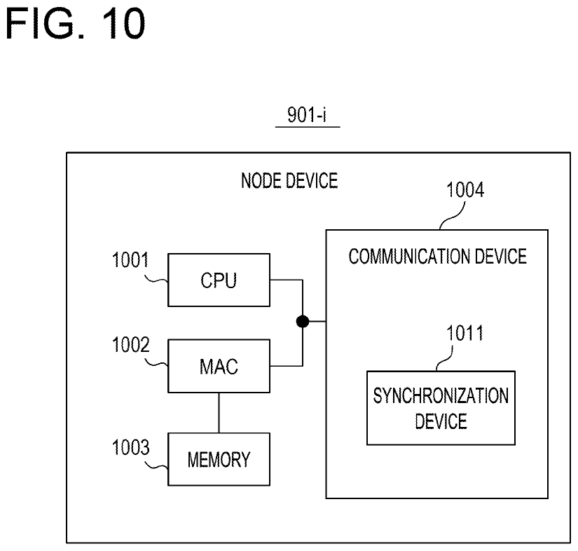

FIG. 10 illustrates an example of a configuration of the node device 901-i of FIG. 9. As illustrated in FIG. 9, the node device 901-i includes a central processing unit (CPU) 1001, a memory access controller (MAC) 1002, a memory 1003, and a communication device 1004, and the communication device 1004 includes a synchronization device 1011. The CPU 1001 corresponds to the arithmetic processing device 711 of FIG. 7 and may be referred to as a processor. The synchronization device 1011 corresponds to the synchronization device 712 of FIG. 7.

The CPU 1001 executes a parallel processing program stored in the memory 1003, to generate multiple processes and operate the generated processes. The communication device 1004 is a communication interface circuit such as a network interface card (NIC), and communicates with the other node devices via the communication network 902.

The synchronization device 1011 executes the reduction operation while taking the barrier synchronization among the processes operating in the node devices 901-1 to 901-L, and notifies the operation result to the respective processes. The MAC 1002 controls an access of the CPU 1001 and the synchronization device 1011 to the memory 1003.

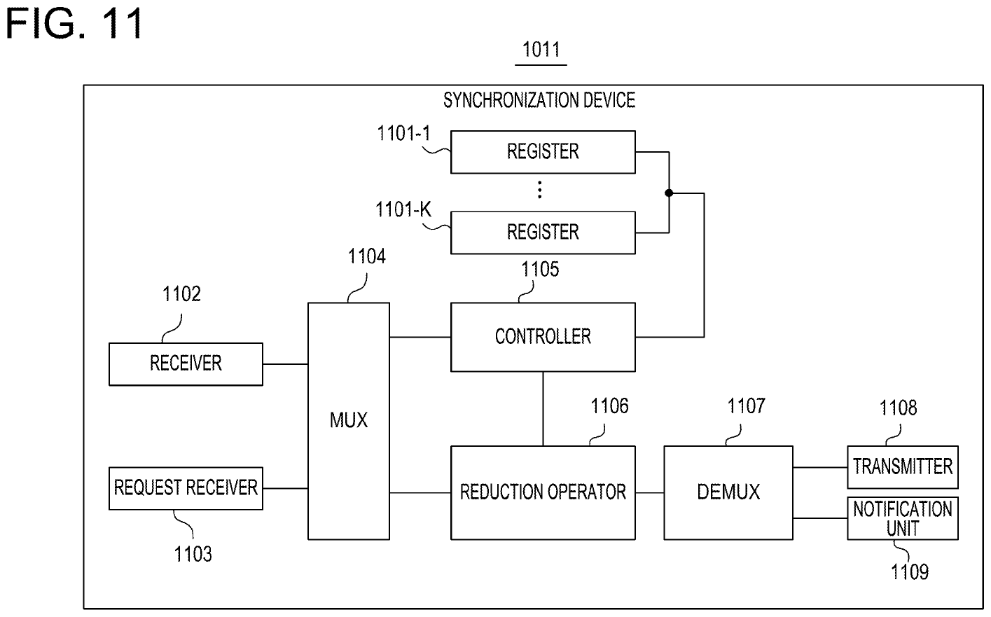

FIG. 11 illustrates a first example of a configuration of the synchronization device 1011 of FIG. 10. As illustrated in FIG. 11, the synchronization device 1011 includes registers 1101-1 to 1101-K (K is an integer of 2 or more), a receiver 1102, a request receiver 1103, and a multiplexer (MUX) 1104. Further, the synchronization device 1011 includes a controller 1105, a reduction operator 1106, a demultiplexer (DEMUX) 1107, a transmitter 1108, and a notification unit 1109.

The registers 1101-1 to 1101-K are reduction resources used for the reduction operation. Among the registers 1101-1 to 1101-K, the p number of registers correspond to the registers 721-0 to 721-(p−1) in FIG. 7 and are used as input/output IFs. The other registers are used as relay IFs.

The reduction operator 1106 and the notification unit 1109 correspond to the reduction operator 722 and the notification controller 723 in FIG. 7, respectively.

The receiver 1102 receives packets from the other node devices, and outputs intermediate data of the reduction operation included in the received packets to the MUX 1104. The request receiver 1103 receives an operation start request and input data generated by the processes in the node device 901-i from the CPU 1001, and outputs the operation start request and the input data to the MUX 1104.

The MUX 1104 outputs the operation start request output by the request receiver 1103 to the controller 1105, and outputs the input data output by the request receiver 1103 and the intermediate data output by the receiver 1102 to the controller 1105 and the reduction operator 1106.

The controller 1105 stores the input data and the intermediate data output by the MUX 1104 in any of the registers 1101-1 to 1101-K. At the time when the reduction operation is started, input data generated by the p number of processes, respectively, are stored in the p number of registers used as input/output IFs. Further, during the intermediate stage of the reduction operation, intermediate data of a standby state are stored in the registers used as relay IFs.

In addition, when the reduction operation is started, the controller 1105 locks the registers used as input/output IFs of the respective processes according to the operation start request from each of the processes, and when the reduction operation is completed, the controller 1105 releases the lock to release the registers. The released registers are used for the next reduction operation.

The reduction operator 1106 executes the reduction operation on multiple pieces of input data or multiple pieces of intermediate data in each stage of the reduction operation, to generate the operation result. Then, the reduction operator 1106 outputs the generated operation result as intermediate or final data to the DEMUX 1107.

The reduction operation may be an operation to obtain a statistical value of input data or a logical operation on input data. As the statistical value, a sum, a maximum value, a minimum value or the like is used, and as the logical operation, an AND operation, an OR operation, an exclusive OR operation or the like is used. For example, as the reduction operator 1106, a 2-input 2-output reduction operator may be used.

The DEMUX 1107 outputs the data of the operation result output by the reduction operator 1106 to the transmitter 1108 and the notification unit 1109. The transmitter 1108 transmits a packet including the data of the operation result to the other node devices.

When the data of the operation result is final data, the notification unit 1109 notifies the data of the operation result to the respective processes in the node device 901-i. For example, as the notification method, any of the following two methods may be used.

(1) Notification Method by a Shared Area

In this notification method, a shared area is provided in the memory 1003, to be shared by the p number of processes. The notification unit 1109 writes the data of the operation result into the shared area through a direct memory access (DMA) to collectively notify the completion of the reduction operation to the p number of processes, and each of the processes reads out the data of the operation result from the shared area in the memory 1003.

(2) Notification Method by a Multicast

In this notification method, p number of areas are provided in the memory 1003, to be used by the p number of processes, respectively. The notification unit 1109 simultaneously writes the data of the operation result into the areas through the direct memory access (DMA) to collectively notify the completion of the reduction operation to the p number of processes, and each of the processes reads out the data of the operation result from the corresponding area in the memory 1003.

According to the notification method by the shared area, the operation result may be notified to the p number of processes, by providing only one area for notifying the operation result. Meanwhile, according to the notification method by the multicast, the operation result may be notified by designating an area of a write destination for each process.

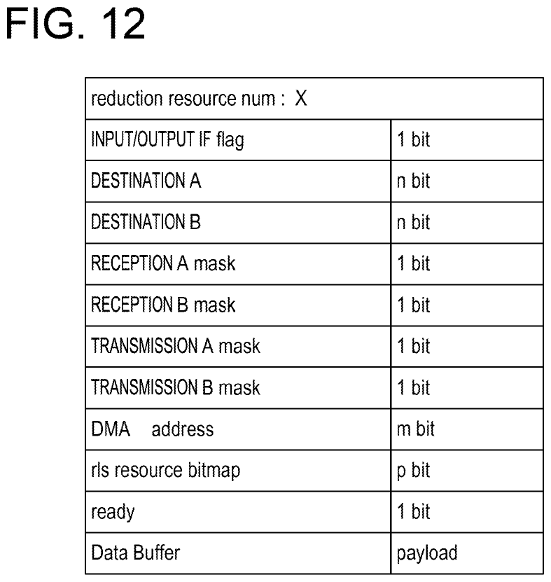

FIG. 12 illustrates an example of information stored in a register 1101-k (k=1 to K) in the notification method by the shared area. In this example, the reduction operation is executed using the 2-input 2-output reduction operator.

The symbol “X” is a reduction resource number and is used as identification information of the register 1101-k. The input/output IF flag is a 1-bit flag indicating whether the register 1101-k is an input/output IF or a relay IF.

Each of the destinations A and B is n-bit destination information indicating a register of the next stage in the reduction operation for each of two outputs of the reduction operator. The number of bits “n” is the number of bits capable of expressing a combination of identification information of a node device in the parallel computer system and identification information of a register in the node device.

Each of the reception A mask and the reception B mask is a 1-bit flag indicating whether to receive the operation result of a previous stage, for each of two inputs of the reduction operator. Each of the transmission A mask and the transmission B mask is a 1-bit flag indicating whether to transfer data to the next stage, for each of two outputs of the reduction operator.

The DMA address is m-bit information indicating an address of the shared area in the memory 1003. The number of bits “m” is the number of bits capable of expressing the address space in the memory 1003.

The “rls resource bitmap” is p-bit information indicating a register to be released when the reduction operation is completed, among the p number of registers used as input/output IFs. A bit value of a logic “1” indicates that a register is to be released, and a bit value of a logical “0” indicates that a register is not to be released. When all of the p number of registers are registers to be released, all bit values of the p number of registers are set to the logic “1.” Meanwhile, when some of the p number of registers are registers to be released, some bit values corresponding to the registers to be released are set to the logic “1.”

The “ready” is a 1-bit flag indicating whether the register 1101-k is in a locked or released state. The released state indicates a state where the reduction operation is completed so that the register 1101-k is released and the operation start request is receivable. Meanwhile, the locked state indicates a state where the register is not released during the execution of the reduction operation so that the operation start request is not receivable. A bit value of a logic “1” indicates the released state, and a bit value of a logic “0” indicates the locked state.

When the operation start request is received from the process corresponding to the register 1101-k, the controller 1105 sets the “ready” to the logic “0,” to lock the register 1101-k. Then, when the reduction operation is completed, the controller 1105 sets the “ready” to the logic “1,” to release the lock.

The “Data Buffer” is information (payload) indicating input data or intermediate data of the reduction operation. When the register 1101-k is used as an input/output IF, input data is stored in the “Data Buffer,” and when the register 1101-k is used as a relay IF, intermediate data is stored in the “Data Buffer.”

The “rls resource bitmap” and the “ready” are set when the register 1101-k is used as an input/output IF. For example, in the released state, when the controller 1105 stores input data in the “Data Buffer” and sets the “ready” to the logic “0,” the reduction operation is started. Alternatively, when the controller 1105 stores input data in the “Data Buffer”, the “ready” is autonomously changed to the logic “0,” and the reduction operation is started.

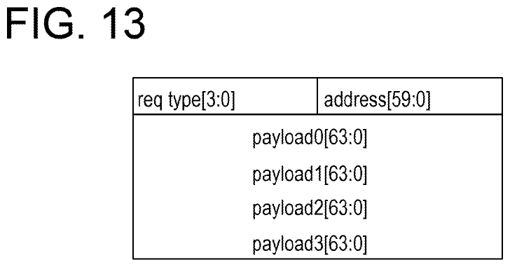

FIG. 13 illustrates an example of the write request output by the notification unit 1109 to the MAC 1002, in the notification method by the shared area. In this example, the reduction operation is executed on vectors, and vectors representing the operation result are generated.

The “req type [3:0]” indicates the type of the reduction operation, and the “address [59:0]” indicates the DMA address of FIG. 12. The “payload0[63:0]” to “payload3[63:0]” indicate four elements of vectors of the operation result.

When a write request is received from the notification unit 1109, the MAC 1002 writes the data of the “payload0[63:0]” to “payload3[63:0]” into the “address[59:0]” in the memory 1003. As a result, the notification unit 1109 may write the vectors of the operation result into the shared area.

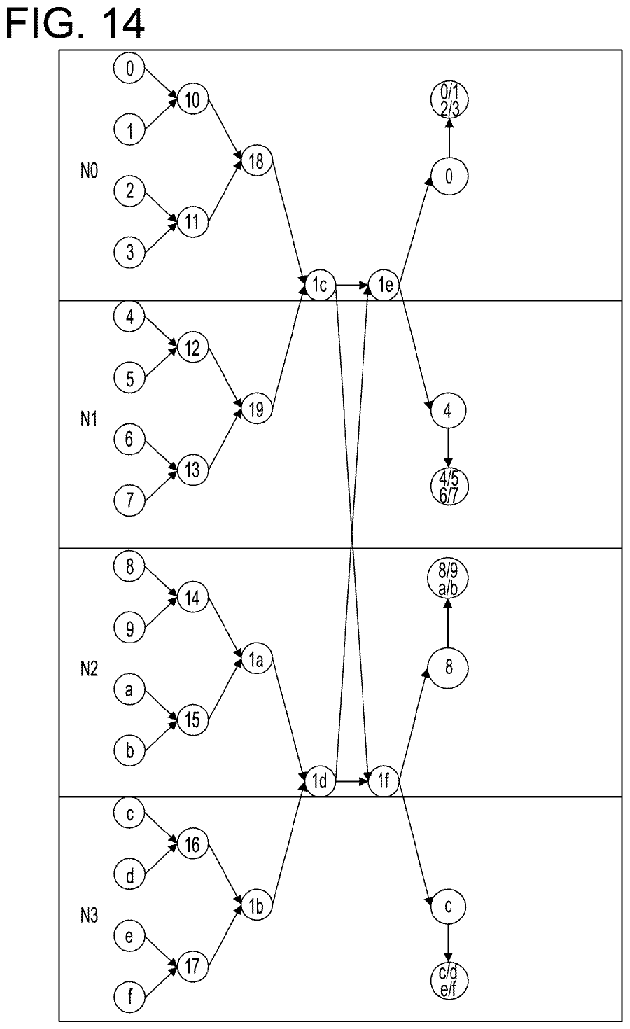

FIG. 14 illustrates an example of a processing flow when the parallel computer system of FIG. 9 executes the reduction operation of FIG. 4. In this example, L=4, and the node devices N0 to N3 correspond to the node devices 901-1 to 901-L of FIG. 9, respectively. Each circle in the node device Ni represents a register 1101-k, and a numeral or character in the circle represents identification information of the register 1101-k.

In the node device N0, registers 0, 1, 2, and 3 are used as input/output IFs to store input data generated by the processes 0, 1, 2, and 3, respectively, at the time when the reduction operation is started. Meanwhile, registers 10, 11, 18, 1c, and 1e are used as relay IFs to store data of a standby state. The register 0 is used as a representative register that is referred-to to notify the operation result in the node device N0.

In the node device N1, registers 4, 5, 6, and 7 are used as input/output IFs to store input data generated by the processes 0, 1, 2, and 3, respectively, at the time when the reduction operation is started. Meanwhile, registers 12, 13, and 19 are used as relay IFs to store data of a standby state. The register 4 is used as a representative register in the node device N1.

In the node device N2, registers 8, 9, a, and b are used as input/output IFs to store input data generated by the processes 0, 1, 2, and 3, respectively, at the time when the reduction operation is started. Meanwhile, registers 14, 15, 1a, 1d, and 1f are used as relay IFs to store data of a standby state. The register 8 is used as a representative register in the node device N2.

In the node device N3, registers c, d, e, and f are used as input/output IFs to store input data generated by the processes 0, 1, 2, and 3, respectively, at the time when the reduction operation is started. Meanwhile, registers 16, 17, and 1b are used as relay IFs to store data of a standby state. The register c is used as a representative register in the node device N3.

In the node device N0, the register 10 stores the sum of the data of the registers 0 and 1, the register 11 stores the sum of the data of the registers 2 and 3, and the register 18 stores the sum of the data of the registers 10 and 11.

In the node device N1, the register 12 stores the sum of the data of the registers 4 and 5, the register 13 stores the sum of the data of the registers 6 and 7, and the register 19 stores the sum of the data of the registers 12 and 13.

In the node device N2, the register 14 stores the sum of the data of the registers 8 and 9, the register 15 stores the sum of the data of the registers a and b, and the register 1a stores the sum of the data of the registers 14 and 15.

In the node device N3, the register 16 stores the sum of the data of the registers c and d, the register 17 stores the sum of the data of the registers e and f, and the register 1b stores the sum of the data of the registers 16 and 17.

The register is in the node device N0 stores the sum of the data of the register 18 in the node device N0 and the data of the register 19 in the node device N1. The register 1d in the node device N2 stores the sum of the data of the register is in the node device N2 and the data of the register 1b in the node device N3.

The register 1e in the node device N0 stores the sum of the data of the register is in the node device N0 and the data of the register 1d in the node device N2. The register 1f in the node device N2 stores the sum of the data of the register 1d in the node device N2 and the data of the register is in the node device N0. The data of the registers 1e and 1f are equal to the sum of the data possessed by the 16 processes.

When the notification method by the shared area is used, the data of the register 1e is the final data of the reduction operation, and thus, is written into the shared area in the memory 1003 using the DMA address stored in the register 0 which is the representative register. As a result, the operation result is collectively notified to the process 0 to process 3 which correspond to the registers 0 to 3, in the node device N0.

The data of the register 1e is also transmitted to the node device N1, and is written into the shared area in the memory 1003 using the DMA address stored in the register 4 which is the representative register. As a result, the operation result is collectively notified to the process 0 to process 3 which correspond to the registers 4 to 7, in the node device N1.

The data of the register 1f is also the final data of the reduction operation, and thus, is written into the shared area in the memory 1003 using the DMA address stored in the register 8 which is the representative register. As a result, the operation result is collectively notified to the process 0 to process 3 which correspond to the registers 8 to b, in the node device N2.

The data of the register 1f is also transmitted to the node device N3, and is written into the shared area in the memory 1003 using the DMA address stored by the register c which is the representative register. As a result, the operation result is collectively notified to the process 0 to process 3 which correspond to the registers c to f, in the node device N3.

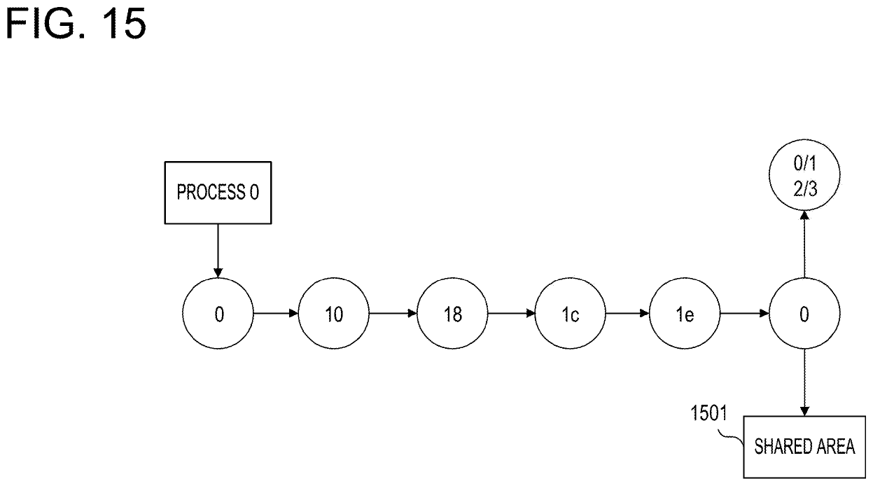

FIG. 15 illustrates an example of a processing flow related to the process 0 when the notification method by the shared area is used in the node device N0 of FIG. 14. When the reduction operation is started, the process 0 locks the register 0 and stores input data in the register 0. Then, when the operation result stored in the register 1e is written into a shared area 1501 in the memory 1003, the registers 0 to 3 are released.

According to the above-described parallel computer system, when the result of the reduction operation is generated, the operation result is written into the shared area so that the completion of the reduction operation is collectively notified to the multiple processes in the node device 901-i. As a result, the redundant notification processing is eliminated, and the latency of the communication device 1004 is reduced, so that the notification costs are reduced. Further, since the operation result is simultaneously notified to the multiple processes, the synchronization deviation accompanied by the notification processing hardly occurs.

In the reduction operation, the processing is executed while taking the inter-process barrier synchronization in each stage. Accordingly, when the completion of the reduction operation is notified to the respective processes, the completion of the barrier synchronization may also be simultaneously notified to the processes.

In the controller 1105, a lock control circuit is provided to generate the ready flag for each register 1101-k used as an input/output IF.

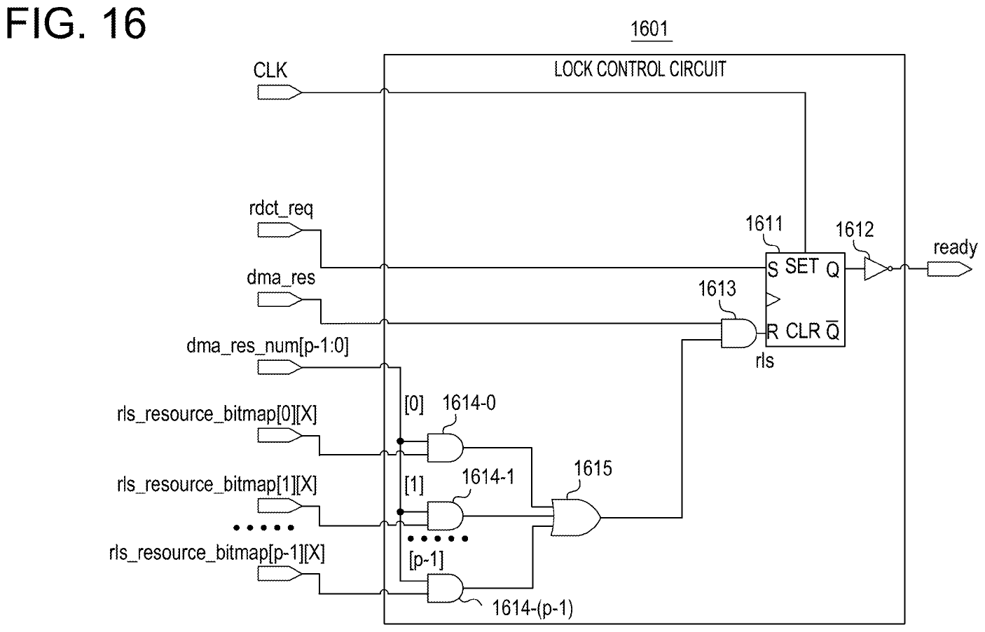

FIG. 16 illustrates an example of a configuration of the lock control circuit. As illustrated in FIG. 16, a lock control circuit 1601 includes a flip-flop (FF) circuit 1611, a NOT circuit 1612, an AND circuit 1613, AND circuits 1614-0 to 1614-(p−1), and an OR circuit 1615.

An input signal CLK is a clock signal. An input signal “rdct_req” is a signal indicating a presence/absence of the operation start request, and becomes a logic “1” when the controller 1105 receives the operation start request. An input signal “dma_res” is a signal indicating whether the notification of the operation result to the p number of processes has been completed, and becomes a logical “1” when the notification of the operation results has been completed.

An input signal “dma_res_num[p−1:0]” is a signal indicating identification information of a representative register, and any one of the p number of registers used as input/output IFs is used as the representative register. The input signal “dma_res_num[p−1:0]” indicates each of p number of bit values corresponding to the p number of registers, respectively, and a signal “dma_res_num[j] (j=0 to p−1)” indicates a bit value corresponding to a j-th register. Among the p number of bit values, a bit value corresponding to the representative register becomes a logic “1.”

An input signal “rls_resource_bitmap[j][X]” indicates an X-th bit value of the rls resource bitmap stored by the j-th register among the p number of registers used as input/output IFs. The X-th bit value is a bit value corresponding to the register 1101-k among the p number of registers.

For example, all of the p number of bit values of the “rls resource bitmaps” stored by the p number of registers, respectively, are set to a logic “1.” In this case, signals of the logic “1” are input as signals “rls resource bitmap[0][X]” to “rls resource bitmap[p−1][X].”

An output signal “ready” is a signal that is stored as a ready flag of the register 1101-k. A signal “rls” is a signal indicating the lock release or not, and becomes a logic “1” when the lock of the register 1101-k is released.

An AND circuit 1614-j outputs the logical product of a signal “dma_res_num[j]” and a signal “rls resource bitmap[j][X].” Accordingly, when the j-th register is the representative register and designates an X-th register as a register to be released, the output of the AND circuit 1614-j becomes a logic “1.”

The OR circuit 1615 outputs the logical sum of outputs of the AND circuits 1614-0 to 1614-(p−1). The AND circuit 1613 outputs the logical product of the signal “dma_res” and the output of the OR circuit 1615 as the signal “rls.”

The FF circuit 1611 operates in synchronization with the signal CLK, and outputs a signal of a logic “1” from a Q terminal when the signal “rdct_req” becomes the logic “1.” Then, when the signal “rls” becomes the logic “1,” the FF circuit 1611 outputs a signal of a logic “0” from the Q terminal.

The NOT circuit 1612 outputs a signal obtained by inverting an output of the FF circuit 1611 as the signal “ready.” Accordingly, when the signal “rdct_req” becomes the logic “1,” the signal “ready” becomes a logic “0,” and when the signal “rls” becomes the logic “1,” the signal “ready” becomes a logic “1.”

According to the lock control circuit of FIG. 16, when the operation result is notified to the p number of processes using the DMA address stored by the representative register among the p number of registers used as input/output IFs, all of the p number of registers are released at once. Thus, the multiple registers may be simultaneously released with the simple circuit configuration.

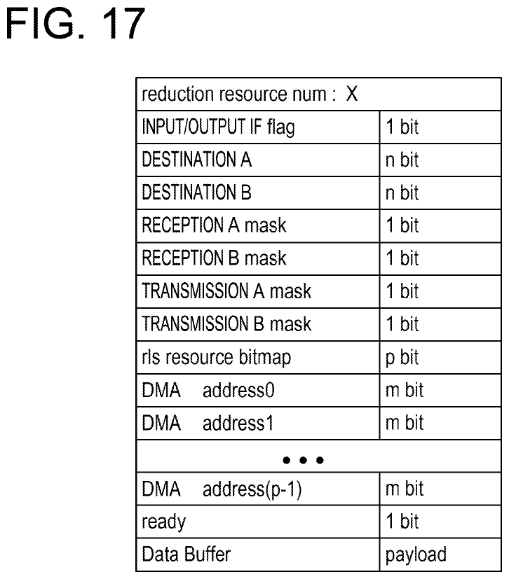

Next, the notification method by the multicast will be described. FIG. 17 illustrates an example of information stored in the register 1101-k, in the notification method by the multicast. The input/output IF flag, the destinations A and B, the reception A mask, the reception B mask, the transmission A mask, the transmission B mask, the “rls resource bitmap,” the “ready,” and the “Data Buffer” are the same as the information illustrated in FIG. 12. In addition, the configuration of the lock control circuit that generates the signal “ready” is the same as illustrated in FIG. 16.

Each of the DMA addresses 0 to (p−1) is m-bit information indicating an address of each of the p number of areas used by the p number of processes in the memory 1003. The number of bits “m” is the number of bits capable of expressing the address space in the memory 1003.

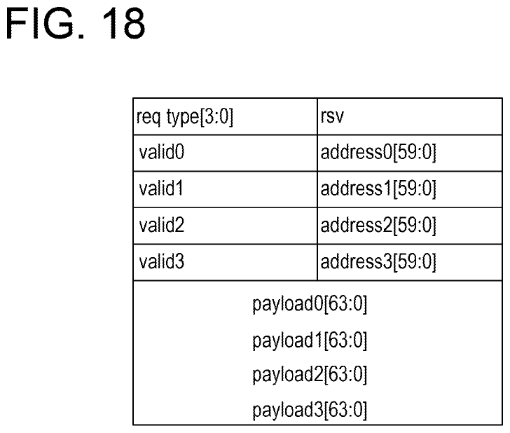

FIG. 18 illustrates an example of a write request output by the notification unit 1109 to the MAC 1002 in the notification method by the multicast. The “req type[3:0]” and the “payload0[63:0]” to “payload3[63:0]” are the same as the information illustrated in FIG. 13.

In this example, p=4 and the “address0[59:0]” to “address3[59:0]” indicate the “DMA address0” to “DMA address(p−1)” of FIG. 17, respectively. The “validj (j=0 to 3)” indicates whether the “addressj[59:0]” is valid. In this case, the J-th bit value of the “rls resource bitmap” in FIG. 17 may be used as the “validj.”

When the write request is received from the notification unit 1109, the MAC 1002 writes the data of the “payload0[63:0]” to “payload3[63:0]” into the “address0[59:0]” to “address3[59:0],” respectively, in the memory 1003. As a result, the notification unit 1109 may simultaneously write the vectors of the operation result into the four areas used by the four processes, respectively.

Next, descriptions will be made on an operation when the notification method by the multicast is used for the processing flow of FIG. 14. In this case, the data of the register 1e is written into each of the four areas in the memory 1003, using the DMA address0 to DMA address3 stored by the register 0 in the node device N0. As a result, the operation result is collectively notified to the process 0 to process 3 which correspond to the registers 0 to 3, in the node device N0.

The data of the register 1e is also transmitted to the node device N1, and is written into each of the four areas in the memory 1003, using the “DMA address0” to “DMA address3” stored by the register 4 in the node device N1. As a result, the operation result is collectively notified to the process 0 to process 3 which correspond to the registers 4 to 7, in the node device N1.

The data of the register 1f is written into each of the four areas in the memory 1003, using the “DMA address0” to “DMA address3” stored by the register 8 in the node device N2. As a result, the operation result is collectively notified to the process 0 to process 3 which correspond to the registers 8 to b, in the node device N2.

The data of the register 1f is also transmitted to the node device N3, and is written into each of the four areas in the memory 1003, using the “DMA address0” to “DMA address3” stored by the register c in the node device N3. As a result, the operation result is collectively notified to the process 0 to process 3 which correspond to the registers c to f, in the node device N3.

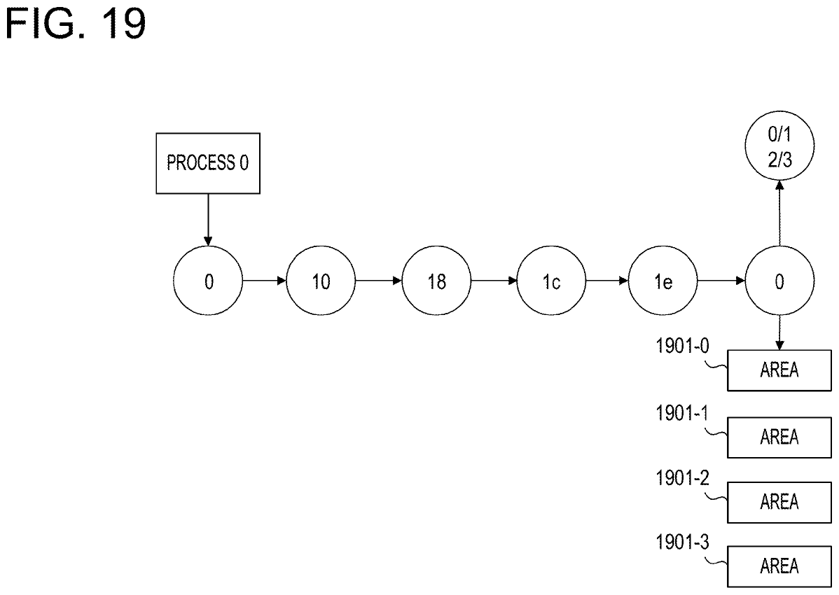

FIG. 19 illustrates an example of a processing flow related to the process 0 when the notification method by the multicast is used in the node device N0. An area 1901-j (j=0 to 3) is an area used by the j-th process in the memory 1003. When the reduction operation is started, the process 0 locks the register 0 and stores input data in the register 0. Then, when the operation result stored in the register 1e is written into areas 1901-0 to 1901-3 in the memory 1003, the registers 0 to 3 are released.

Meanwhile, instead of writing the result of the reduction operation into the memory 1003, the operation result may be written into the p number of registers used as input/output IFs, to notify the operation result to the p number of processes. In this case, each processor reads out the operation result from the corresponding register to acquire the operation result.

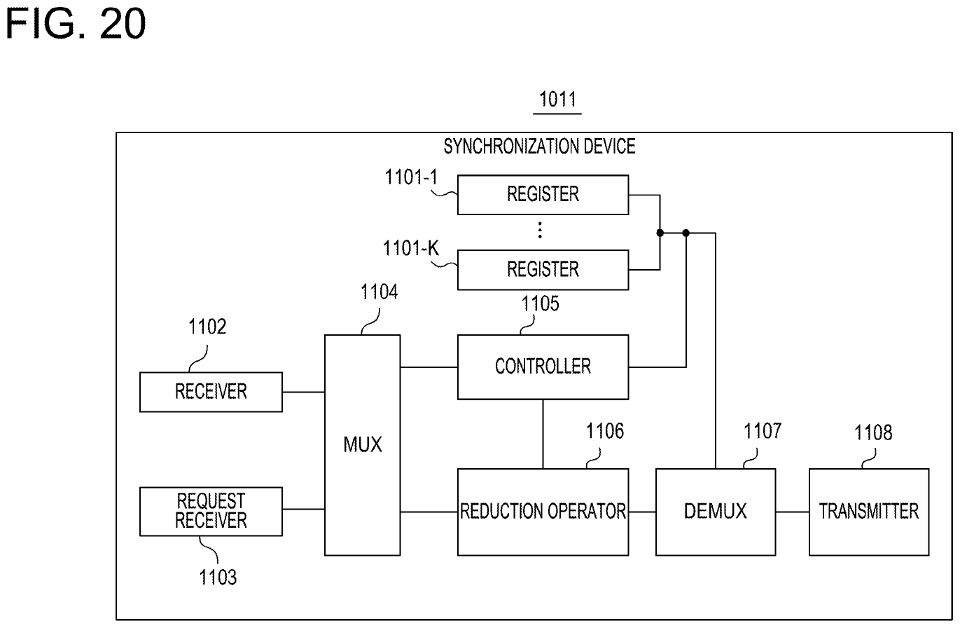

FIG. 20 illustrates a second example of the configuration of the synchronization device 1011 using a notification method by registers. As illustrated in FIG. 20, the synchronization device 1011 has a configuration in which the notification unit 1109 of the synchronization device 1011 of FIG. 11 is omitted. In this case, the controller 1105 and the DEMUX 1107 operate as the notification controller 723 of FIG. 7.

When the data of the operation result is final data, the DEMUX 1107 outputs the data of the operation result to the p number of registers used as input/output IFs, among the registers 1101-1 to 1101-K, and each register stores the data of the operation result. At this time, the controller 1105 sets the “ready” of the p number of registers to the logic “1,” to collectively notify the completion of the reduction operation to the p number of processes in the node device 901-i.

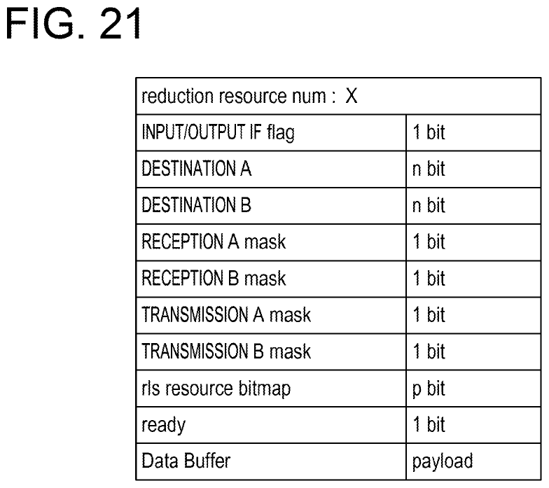

FIG. 21 illustrates an example of information stored in the register 1101-k in the notification method by the registers. The input/output IF flag, the destinations A and B, the reception A mask, the reception B mask, the transmission A mask, the transmission B mask, the “rls resource bitmap,” and the “ready” are the same as the information illustrated in FIG. 12. In addition, the configuration of the lock control circuit that generates the ready flag is the same as the configuration illustrated in FIG. 16.

The “Data Buffer” is information (payload) indicating input data, intermediate data or final data of the reduction operation. In a case where the register 1101-k is used as an input/output IF, input data is stored in the “Data Buffer” at the time when the reduction operation is started, and final data is stored in the Data Buffer when the reduction operation is completed. Meanwhile, in a case where the register 1101-k is used as a relay IF, intermediate data is stored in the “Data Buffer.”

Each process in the node device 901-i monitors the value of the “ready” of the corresponding register by polling, and detects the completion of the reduction operation when the “ready” changes to the logic “1.” Then, each process reads out the Data Buffer stored by the register to acquire the data of the operation result.

Next, descriptions will be made on an operation when the notification method by the registers is used for the processing flow of FIG. 14. In this case, the data of the register 1e is written into each of the registers 0 to 3 in the node device N0, and the ready flags of the registers are set to the logic “1.” As a result, the operation result is collectively notified to the process 0 to process 3 which correspond to the registers 0 to 3, in the node device N0.

The data of the register 1e is also transmitted to the node device N1, and is written into each of the registers 4 to 7 in the node device N1, and the ready flags of the registers are set to the logic “1.” As a result, the operation result is collectively notified to the process 0 to process 3 which correspond to the registers 4 to 7, in the node device N1.

The data of the register 1f is written into each of the registers 8 to b in the node device N2, and the ready flags of the registers are set to the logic “1.” As a result, the operation result is collectively notified to the process 0 to process 3 which correspond to the registers 8 to b, in the node device N2.

The data of the register 1f is also transmitted to the node device N3, and is written into each of the registers c to fin the node device N3, and the ready flags of the registers are set to the logic “1.” As a result, the operation result is collectively notified to the process 0 to process 3 which correspond to the registers c to f, in the node device N3.

According to the notification method by the registers, since the register 1101-k which is the reduction resource is used as a notification destination, information for designating an address in the memory 1003 becomes unnecessary, so that the amount of the information of the register 1101-k is reduced. Further, since the ready flags and the “Data Buffer” of the p number of registers in the same node device are rewritten simultaneously, the synchronization deviation accompanied by the notification processing is only a result of the polling by each processing.

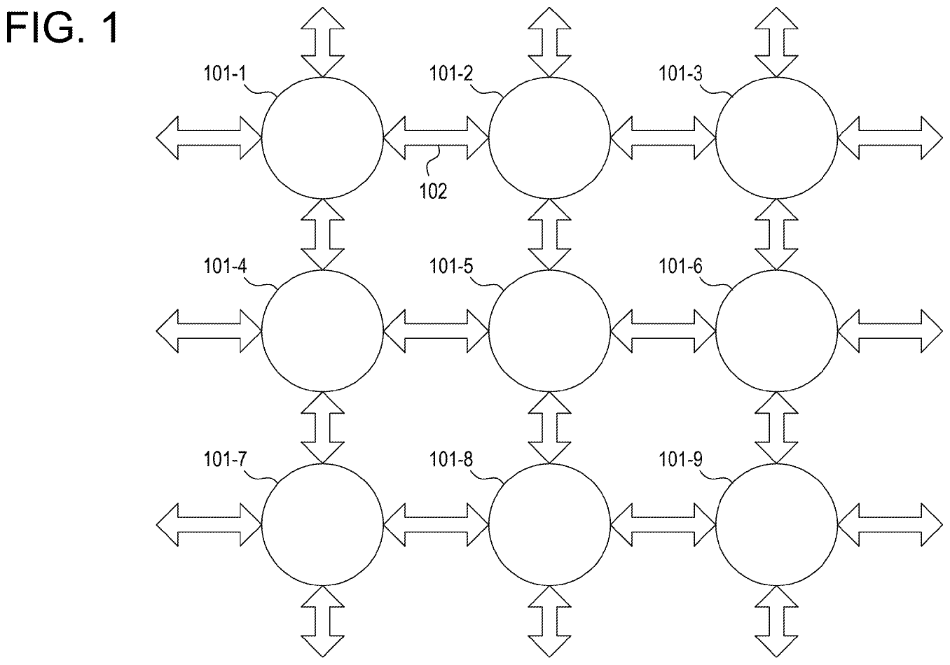

The configuration of the parallel computer system of FIGS. 1 and 9 is merely an example, and the number of node devices included in the parallel computer system and the connection form of the node devices change according to the application or condition of the parallel computer system.

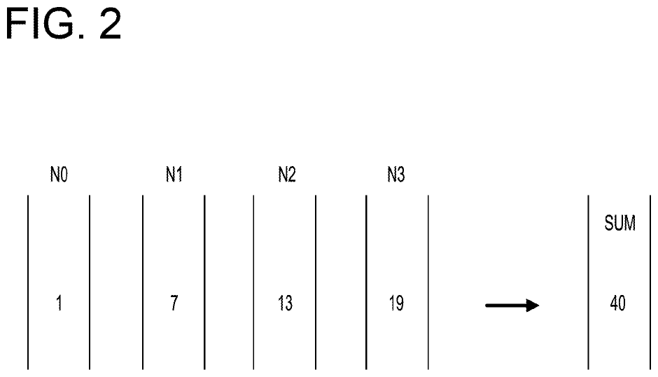

The reduction operation of FIGS. 2 and 4 is merely an example, and the reduction operation changes according to the type of the operation and the input data. The processes of FIG. 3 are merely an example, and the number of processes in each node device changes according to the application or condition of the parallel computer system. The processing flows of FIGS. 5, 6, 14, 15, and 19 are merely an example, and the processing flow of the reduction operation changes according to the configuration or condition of the parallel computer system and the number of processes generated in each node device.

The configuration of the node device in FIGS. 7 and 10 is merely an example, and some of the components of the node device may be omitted or changed according to the application or condition of the parallel computer system. The configuration of the synchronization device 1011 of FIGS. 11 and 20 is merely an example, and some of the components of the synchronization device 1011 may be omitted or changed according to the application or condition of the parallel computer system.

The configuration of the lock control circuit 1601 of FIG. 16 is merely an example, and some of the components of the lock control circuit 1601 may be omitted or changed according to the configuration or condition of the parallel computer system. The lock control circuit 1601 may be provided for each of the registers 1101-1 to 1101-K in FIGS. 11 and 20, and a register to be used as an input/output IF may be selected from the registers.

The flowchart of FIG. 8 is merely an example, and some of the processes in the flowchart may be omitted or changed according to the configuration or condition of the parallel computer system

The information of the register in FIGS. 12, 17, and 21 is merely an example, and some of the information may be omitted or changed according to the configuration or condition of the parallel computer system. The write request in FIGS. 13 and 18 is merely an example, and some of the information of the write request may be omitted or changed according to the configuration or condition of the parallel computer system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A node device comprising:
a processor; and
a synchronization circuit including:
a plurality of registers configured to store respective data of a plurality of processes that are generated by the processor;
a reduction operator configured to execute a reduction operation on the data of the plurality of processes and data of other processes generated in another node device, to generate an operation result of the reduction operation; and
a controller configured to collectively notify of a completion of the reduction operation to the plurality of processes when the operation result is generated.

2. The node device according to claim 1, further comprising:
a memory that includes a shared area which is shared by the plurality of processes,
wherein
one of the plurality of registers is further configured to store an address of the shared area, and
the controller is further configured to write the operation result into the shared area by using the address of the shared area, which is stored in the one of the plurality of registers, to notify of the completion of the reduction operation to the plurality of processes.

3. The node device according to claim 1, further comprising:
a memory that includes a plurality of areas which are respectively used by the plurality of processes,
wherein
one of the plurality of registers is further configured to store an address of each of the plurality of areas, and
the controller is further configured to write the operation result into the plurality of areas by using the address of each of the plurality of areas which is stored in the one of the plurality of registers, to notify of the completion of the reduction operation to the plurality of processes.

4. The node device according to claim 1, wherein
each of the plurality of registers is further configured to store a flag that indicates a locked state or a released state, the locked state indicating a state where a register is not released due to the execution of the reduction operation, the released state indicating a state where a register is released due to the completion of the reduction operation, and
the controller is further configured to:
set the flag stored in each of the plurality of registers to indicate the locked state when the reduction operation is started; and
set the flag stored in each of the plurality of registers to indicate the released state when the operation result is generated.

5. The node device according to claim 1, wherein
each of the plurality of registers is further configured to store a flag that indicates a locked state or a released state, the locked state indicating a state where a register is not released due to the execution of the reduction operation, the released state indicating a state where a register is released due to the completion of the reduction operation, and
the controller is further configured to:
set the flag stored in each of the plurality of registers to indicate the locked state when the reduction operation is started; and
store the operation result in each of the plurality of registers and set the flag stored in each of the plurality of registers to indicate the released state when the operation result is generated, to notify of the completion of the reduction operation to the plurality of processes.

6. A parallel computer system comprising:
a plurality of node devices each including:
a processor; and
a synchronization circuit including:
a plurality of registers configured to store respective data of a plurality of processes that are generated by the processor;
a reduction operator configured to execute a reduction operation on the data of the plurality of processes and data of other processes generated in another node device, to generate an operation result of the reduction operation; and
a controller configured to collectively notify of a completion of the reduction operation to the plurality of processes when the operation result is generated.

7. The parallel computer system according to claim 6, wherein
each of the plurality of node devices further includes:
a memory that includes a shared area which is shared by the plurality of processes, and
one of the plurality of registers is further configured to store an address of the shared area, and
the controller is further configured to write the operation result into the shared area by using the address of the shared area, which is stored in the one of the plurality of registers, to notify of the completion of the reduction operation to the plurality of processes.

8. The parallel computer system according to claim 6, wherein
each of the plurality of node devices further includes:
a memory that includes a plurality of areas which are respectively used by the plurality of processes,
wherein
one of the plurality of registers is further configured to store an address of each of the plurality of areas, and
the controller is further configured to write the operation result into the plurality of areas by using the address of each of the plurality of areas which is stored in the one of the plurality of registers, to notify of the completion of the reduction operation to the plurality of processes.

9. The parallel computer system according to claim 6, wherein
each of the plurality of registers is further configured to store a flag that indicates a locked state or a released state, the locked state indicating a state where a register is not released due to the execution of the reduction operation, the released state indicating a state where a register is released due to the completion of the reduction operation, and
the controller is further configured to:
set the flag stored in each of the plurality of registers to indicate the locked state when the reduction operation is started; and
set the flag stored in each of the plurality of registers to indicate the released state when the operation result is generated.

10. The parallel computer system according to claim 6, wherein
each of the plurality of registers is further configured to store a flag that indicates a locked state or a released state, the locked state indicating a state where a register is not released due to the execution of the reduction operation, the released state indicating a state where a register is released due to the completion of the reduction operation, and
the controller is further configured to:
set the flag stored in each of the plurality of registers to indicate the locked state when the reduction operation is started; and
store the operation result in each of the plurality of registers and set the flag stored in each of the plurality of registers to indicate the released state when the operation result is generated, to notify of the completion of the reduction operation to the plurality of processes.

11. A method of controlling a parallel computer system, the method comprising:
storing, by each of a plurality of computers, respective data of a plurality of processes in a plurality of registers included in the plurality of computers, the plurality of processes being generated by each of the plurality of computers;
executing a reduction operation on the data of the plurality of processes and data of other processes generated in another computer, to generate an operation result of the reduction operation; and
collectively notifying of a completion of the reduction operation to the plurality of processes when the operation result is generated.

12. The method according to claim 11, further comprising:
writing the operation result into a shared area of a memory by using an address of the shared area to notify of the completion of the reduction operation to the plurality of processes, the shared area being shared by the plurality of processes, the address being stored in one of the plurality of registers.

13. The method according to claim 11, further comprising:
writing the operation result into a plurality of areas of a memory by using an address of each of the plurality of areas to notify of the completion of the reduction operation to the plurality of processes, the plurality of areas being respectively used by the plurality of processes, the address being stored in one of the plurality of registers.

14. The method according to claim 11, further comprising:
setting a flag stored in each of the plurality of registers to indicate a locked state when the reduction operation is started, the locked state indicating a state where a register is not released due to the execution of the reduction operation; and
setting the flag to indicate a released state when the operation result is generated, the released state indicating a state where a register is released due to the completion of the reduction operation.

15. The method according to claim 11, wherein
setting a flag stored in each of the plurality of registers to indicate a locked state when the reduction operation is started, the locked state indicating a state where a register is not released due to the execution of the reduction operation; and
storing the operation result in each of the plurality of registers and setting the flag to indicate a released state when the operation result is generated, to notify of the completion of the reduction operation to the plurality of processes, the released state indicating a state where a register is released due to the completion of the reduction operation.
